(19) United States
(12) Patent Application Publication
(10) Pub. No.: US 2003/0163501 A1
(43) Pub. Date: Aug. 28, 2003

(54) Implementation to avoid overflow in IIR filter

(75) Inventors: Chinping Q. Yang, Cupertino, CA (US); Robert Weixiu Du, Danville, CA (US)

Correspondence Address: WOOD, HERRON & EVANS, LLP, 2700 CAREW TOWER, 441 VINE STREET, CINCINNATI, OH, 45202, US

(73) Assignee: Sony Corporation and Sony Electronics Inc.

(21) Appl. No.: 09/870,026

(22) Filed: May 30, 2001

(51) Int. Cl. G06F 17/10; G06F 7/38

(52) U.S. Cl. 708/552; 708/320

(57) ABSTRACT

Method and apparatus for reducing the occurrence of overflow in an IIR filter. The feedback state of a filter is stored with double precision and scaled-down to increase range.

### FIELD OF THE INVENTION

The present invention relates to digital IIR filters, and more particularly to an apparatus and method for avoiding filter state overflow in the same.

### BACKGROUND OF THE INVENTION

Digital filters have broad application in the technology industries. Such filters typically embody a computational process, or algorithm, that transforms a discrete sequence of input numbers into another discrete sequence of output numbers. Technically, a digital filter imputes a modified frequency domain spectrum onto the generated output numbers. This property has particular application within the communication, entertainment and electronics fields.

Digital filters mathematically manipulate a sequence of binary bits that encode a sample, such as the bits embodied in the exemplary audio packet of FIG. 1. The illustrated packet includes a linear pulse code modulated (LPCM) block header carrying parameters (e.g. gain, number of channels, bit width, bit rate, compression information, as well as video coordination and frequency identifiers) used by an audio decoder. Following the header block, the audio data packet contains any number of audio samples. The block header 10 is shown in the packet 12 of FIG. 1 along with a block of audio data 14. The format of the audio data is dependent on the bit-width of the samples.

During digitization, a microphone converts a varying air pressure from sound waves into voltage readings. An analog-to-digital converter samples the voltage at regular intervals of time. For example, in a compact disc audio recording, there are exactly 44,100 samples taken every second. Each sampled voltage converts into a binary string, which is recorded with a preset precision. The precision refers to the number of bits allotted to store each sample within the packet. For instance, the sample of FIG. 2A may be stored with 30 bits. The accuracy of a stored sample varies proportionally with its precision. Thus, a sample stored with 48 bits may more accurately reflect an original sample than the same signal stored with 24 bits. Increased precision, however, requires the expenditure of additional processing and storage resources not conventionally warranted by increased fidelity.

A digital filter commonly relied upon in digital signal processing (DSP) applications is an infinite impulse response (IIR) filter (also known as a recursive filter). The filter derives its name from an “infinite” feedback property programmed into the filter. The equation below describes how the output, y, of an infinite impulse response filter is calculated from an input, x.

$${y}_{n} = {\sum }_{i = 0}^{P - 1} {c}_{i} {x}_{n - i} + {\sum }_{j = 1}^{Q} {d}_{j} {y}_{n - j}$$

The c array holds P moving average portion of the filter coefficients. The d array holds weighting coefficients for feeding back the previous Q outputs into the current output value.

Varying frequencies cause IIR filters to behave differently. The following equation demonstrates the relationship between the input and output as a function of frequency:

$$H ( f ) ⇐ \frac{{\sum }_{i = 0}^{P - 1} {c}_{j} {ⅇ}^{2 π jfT}}{1 - {\sum }_{K = 1}^{Q} {d}_{k} {ⅇ}^{2 π kfT}}$$

ƒ is the frequency in Hz and T is the time between samples expressed in seconds (reciprocal of the sampling rate). H(f) is the Fourier Transform of the IIR filter's impulse response.

Theoretically, a single impulse, “1,” followed by “0” samples will cause the IIR filter to output an infinite number of non-zero values. This performance characteristic contrasts an IIR filter from other digital filters, whose output eventually tapers to zero. This property is enabled by virtue of a recursion coefficients present in the filter. The recursion feeds back previous outputs to the calculation of the current output sample.

While IIR filters are more efficient in the sense that they need fewer filter coefficients to generate the desired response characteristics than finite impulse response (FIR) filters, they are harder to design, and can suffer from stability problems if improperly implemented in a finite precision computing machine. Such problems commonly stem from the inherent feedback characteristic. For instance, when the output is imperfectly computed and fed back, the imperfection may compound in the next processing iteration. When the feedback is imprecise, the IIR filter becomes unstable. More particularly, this imprecision causes the filter output to oscillate out of control. As such, input fed back into the filter may diverge exponentially to infinity. In software, this divergence can cause a crash due to data overflow.

Overflow may occur where the bit-length of an output signal exceeds the preset bit width of the filter. As a result, the signal may become clipped as shown in FIG. 2B. That is, for a filter having a 24-bit width, any values larger than 2²³ will be clipped. As evident from the drawings of FIG. 2, the clipped signal 2B is no longer representative of the original signal 2A. Nonetheless, the filter stores the imprecise, clipped signal 2B as feedback. Because the clipped signal of FIG. 2B is further used to modify an incoming pulse, the output of the filter becomes skewed when the clipped data is fed back into the DSP. In this manner, the overflow error propagates for many iterations, consistently corrupting the output.

Occasionally, an overflow situation will correct itself over time if a saturated feedback signal is summed with a low decibel sample. However, a single overflow event more likely causes a cascading effect in subsequent processing layers. Therefore, there is a significant need for a manner of processing a signal within an IIR filter that avoids overflow.

### SUMMARY OF THE INVENTION

The method, apparatus and program product of the present invention relates to reducing the occurrence of overflow within a digital IIR filter. Such filters conventionally use feedback to modify an incoming signal. One embodiment increases the precision with which a feedback signal is recorded. For instance, the feedback maybe buffered using double precision.

The embodiment may then discard at least one bit from the feedback signal.

This discarded bit may comprise the least significant bit of the feedback signal.

The above and other objects and advantages of the present invention shall be made apparent from the accompanying drawings and the description thereof.

The above and other objects and advantages of the present invention shall be made apparent from the accompanying drawings and the description thereof.

### BRIEF DESCRIPTION OF THE DRAWING

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 shows an example of an LPCM formatted data packet;

FIGS. 2A and 2B show examples of digitally sampled and processed signals.

FIG. 3 is a block diagram that generically illustrates an IIR filter environment that is consistent with the principles of the present invention.

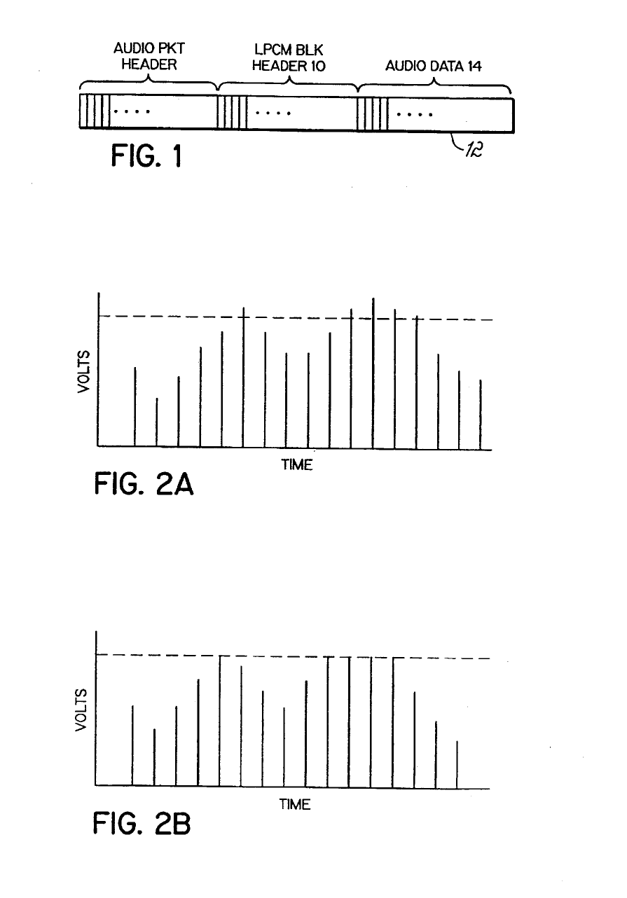

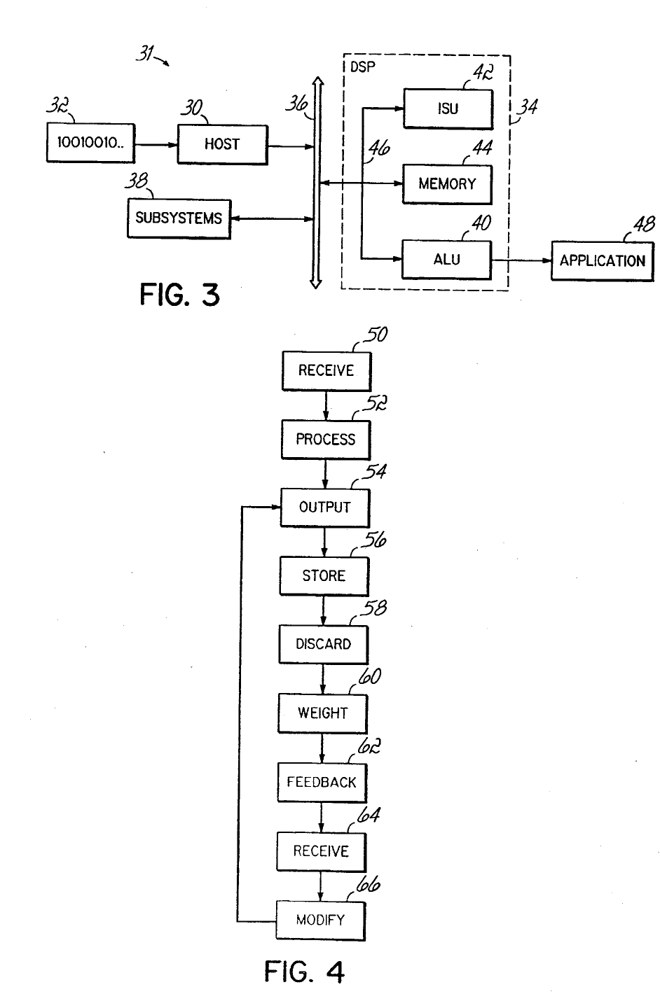

The flowchart of FIG. 4 features processing steps suited for execution within the hardware environment of FIG. 3.

### DETAILED DESCRIPTION OF THE SPECIFIC EMBODIMENTS

The invention relates to a method and apparatus for reducing the occurrence of overflow in an IIR filter. One embodiment increases the range of the feedback state by doubling the precision with which it is stored. A least significant bit of the feedback state is then discarded in anticipation of its recombination with an incoming signal.

Turning to the drawings, the block diagram of FIG. 3 illustrates a signal processing circuit environment 31 that is consistent with the principles of the present invention. The circuit may include a digital signal processor (DSP) 34 configured to mathematically manipulate a sequence of bits conveyed by a digital packet 32. The output of the filter feeds a post-processing chip or software algorithm for subsequent processing. The DSP 34 simultaneously stores the output of the filter as feedback. The filter may increase the precision with which the feedback is stored. The DSP 34 may discard a least significant bit of the feedback state prior to using it to modify an incoming signal. In this manner, the embodiment ensures greater range and prevents overflow when the time domain gain of the IIR filter remains under 6 dB.

Turning more particularly to FIG. 3, the exemplary signal processing circuit 31 includes a digital signal processor (DSP) 34, a host 30, or suitable microprocessor and an internal transfer bus 36 for connecting the DSP 34 to the host 30. The bus 36 may also connect other subsystems 38 to both the host 30 and processor 34. As is conventional, the DSP 34 may include an arithmetic-logic unit (ALU) 40, an instruction storage unit (ISU) 42, a cache of memory blocks 44, as well as other well-known and conventional components (not shown). A processor data bus 46 connects all DSP components to each other and to the internal transfer bus 36.

In one embodiment, the host 30 may receive, maintain and transmit audio data, programs and other instructions required by the DSP 34. Such data and instructions may be initially loaded into the main memory of the host 30 from Read Only Memory (ROM), disk units, or other peripheral devices that might be found in the other subsystems 30. The host 30 may communicate the resident data and instructions to the DSP 34 over the internal transfer bus 36. In another embodiment, the functions of the host 30 may be incorporated within the DSP 34.

In either case, a digital packet 32 arrives at a DSP microchip 34 configured to decode the string of binary bits that define it. The DSP 34 may retrieve processing instructions from the header block preceding the binary data in order to accurately reproduce the embodied signal. Typically, each bit of the sequence is sampled by the microchip 34 in the order presented. The instructions may initiate processing sequences within the ISU 42 that are communicated to the ALU 40. The ALU 40 of the DSP chip 34 mathematically manipulates the packet 32 according to the processing algorithms designated by the ISU 42. In response to each instruction from the ISU 42, the ALU 40 will fetch and operate on data from memory 44 in accordance with microinstructions. The ALU 40 holds control information, such as pointers to ISU 42 structures and memory blocks. The DSP 34 ultimately outputs the processed bit sequence to a playback device 48, such as an audio system. The DSP 34 additionally stores the output within its memory 44 as an integer sequence comprising a feedback state.

As discussed above, conventional filter arrangements may widely oscillate in response to imprecise feedback. To improve the integrity of the feedback signal, the DSP 34 may store filter output with double precision. Precision refers to the number of bits used to store a sample. For instance, the DSP 34 digitally reconstructs a sample stored with 24 bit precision using only 24 binary measurements. The same signal, recorded with 48-bit precision, is encoded with twice the number of bits, translating into increased accuracy. Though the increased precision burdens processing and memory resources, it allows the signal to be reproduced with twice the data integrity. Practically, doubted precision serves to tighten-up the feedback for a next processing iteration. This heightened accuracy decreases the likelihood that the input signal will corrupt the output of the filter.

Despite the increased precision, the feedback state may still be prone to initiate overflow error. Consequently, the ISU 42 may instruct the ALU 40 to discard the least significant bit from the feedback stored in memory.

In one embodiment, the ALU 40 may discard the bit by shifting the binary placeholders comprising the feedback. For instance, the ALU 40 may shift the feedback one bit to the right. As such, the bit of the feedback state located furthest to the right will fall outside of the DSP register. As such, the bit, which corresponds to the least significant bit, is not fed back and shifting the state to the right one bit approximately halves the numerical value of the feedback and further leaves the binary placeholder corresponding to the most significant bit unoccupied. Thus, the scaling operation creates headroom adequate to accommodate overflow occurrences. The least significant bit in the feedback states is effectively discarded.

The least significant bit further corresponds to the binary digit of the bit sequence that occupies the lowest binary value. For instance, in a sample that is four bits in length, “1101,” the first digit of the sequence carries a binary value of eight. The last digit of the string indicates a smaller binary value of one. Thus, the last digit, which occupies the smallest binary placeholder, is said to be less significant than the first. In the above example, the last digit is eight times more significant than the first, or least significant bit. Although discarding a bit technically sacrifices some precision, the effects stemming from the loss of a single, least significant bit in a 48 bit, double precision application are relatively negligible. For instance, a least significant bit within such an application may be 1.4×10¹⁴ smaller than a most significant bit presented to the filter.

Thus in discarding the least significant bit, the embodiment may capitalize on a byproduct of double precision. Namely, the increased fidelity of the feedback state enables the DSP 34 to discard a bit without substantially corrupting the audio data. As such, a least significant bit may be sacrificed to reduce the occurrence of overflow. Precision losses are justified by increased range and process headroom. By scaling-down the recursive states, the embodiment ensures that the feedback state will contain at least one bit-worth of available range. This range largely decreases the occurrence of overflow incident with the arrival of the feedback at the DSP 34. At the output, the state downscaling is compensated to get the desired value. Although the output signal could be clipped, it will contribute to the filter recursion and will not cause instability of the systems.

The stored feedback may additionally be weighted or tuned by the ALU 40 to achieve a desired filter effect. For instance, the processor may multiply the feedback signal by a preset scaling factor. The factor may be used to stabilize the effects of the feedback within the filtration system. Weights may additionally be configured to achieve other processing subtleties, depending on the application of the signal.

The filter may again store the weighted feedback within memory 44, or may transmit it directly to the ALU 40 for recombination and further processing. The DSP 34 may simultaneously receive and transmit a second audio sample to the ALU 40. The ISU 42 may send instructions to modify an incoming sample according to the feedback at the ALU 40. As before, the filter may output the modified signal to the playback system. The DSP 34 may likewise store the output with double precision in anticipation of future scaling, weighting and other processing operations of the DSP 34.

The flowchart of FIG. 4 illustrates filtering process steps that may be executed within the exemplary hardware environment of FIG. 3. At block 50, a bitstream arrives at a DSP microchip configured to decode the string of binary bits. An exemplary bit sequence may encode a digital audio signal. The DSP may retrieve processing instructions from the header block preceding the audio data in order to accurately reproduce the embodied signal. Typically, each bit of the sequence is sampled by the microchip in the order presented. The DSP chip processes the sample at block 52 of FIG. 4. Processing includes mathematically manipulating, the bit sequence according to the designated processing algorithms.

At block 54, an output from the DSP registers at a playback device, such as an audio system. The DSP records the output of the filter as feedback in memory at block 56. To decrease output intensity and unpredictability, the filter may store the feedback state using double precision. As the name implies, the level of precision used to record a sample is directly proportional to the accuracy with which the sample is reproduced. Thus, improved signal integrity may stem from an increased volume of signal parameters being recorded in high precision applications. This heightened accuracy decreases the likelihood that the feedback signal will ultimately corrupt the output of the filter.

Despite the increased precision afforded by block 56, the feedback state may still tolerate overflow complications. Consequently, the DSP may shift the state one bit to the right, discarding the least significant bit from the feedback at block 58. The least significant bit corresponds to the binary digit of the bit sequence that occupies the lowest binary value position within the string. This digit is said to be less significant than the larger.

Thus in executing block 58, the embodiment capitalizes on a byproduct of double precision operation of block 56. More specifically, the embodiment recognizes that signals stored with double precision may not require every bit in order to ensure accurate reproduction. This bit may be discarded without significantly affecting the integrity of the signal reproduction process. While even such a small sacrifice does detract from the precision of the overall feedback state, the relatively insignificant loss is justified by increased processing headroom. Namely, the shifting step 58 ensures that the feedback state will contain at least one bit-worth of available range. This range may largely decrease the occurrence overflow.

The stored feedback value may be multiplied by a scaling coefficient at block 60. One embodiment may mathematically weight the feedback value to stabilize and tune the effects of the feedback signal. Weights may additionally be configured to achieve other processing subtleties.

The filter transmits the resultant feedback signal to the processing components of the DSP at block 62. At block 64, the DSP receives a second signal. The DSP modifies and otherwise processes the second signal in conjunction with the feedback at block 66. As before, the resultant signal may be output to the playback system at block 64. At block 66, the output may likewise be stored with double precision prior to being scaled and modified as before at blocks 58-66.

While the present invention has been illustrated by a description of various embodiments and while these embodiments have been described in considerable detail, it is not the intention of the applicants to restrict or n any way limit the scope of the appended claims to such detail. Additional advantages and modifications will readily appear to those skilled in the art. The invention in its broader aspects is therefore not limited to the specific details, representative apparatus and method, and illustrative example shown and described. For instance, IIR filters consistent with the principles of the present invention may include a software routine operating on data stored in computer memory, as well as dedicated digital hardware. Accordingly, departures may be made from such details without departing from the spirit or scope of applicant's general inventive concept.

What is claimed is:

1. Method for preventing overflow within a digital IIR filter, wherein the filter uses a feedback signal to modify an incoming signal, wherein the feedback signal comprises a sequence of bits, comprising discarding at least one bit from the feedback signal.

2. The method according to claim 1, further comprising increasing the precision with which a feedback signal is recorded.

3. The method according to claim 2, further comprising buffering the feedback signal with double precision.

4. The method according to claim 1, further comprising discarding a least significant bit of the feedback signal.

5. The method according to claim 1, further comprising shifting the feedback signal one bit toward a less significant bit.

6. The method according to claim 1, further comprising communicating the feedback signal to a microprocessor.

7. The method according to claim 1, further comprising receiving the incoming signal.

8. The method according to claim 1, further comprising modifying the incoming signal using the feedback signal to produce a modified signal.

9. The method according to claim 8, further comprising multiplying the modified signal by a scaling coefficient.

10. The method according to claim 8, further comprising outputting the modified signal.

11. The method according to claim 1, further comprising determining when discarding a bit from the feedback signal is required to avoid overflow.

12. An apparatus for preventing overflow within a digital IIR filter, wherein the filter uses a feedback signal to modify an incoming signal, wherein the feedback signal comprises a sequence of bits, comprising:
a memory;
program code configured to initiate the storage of the feedback signal within the memory, wherein program code is further configured to initiate the discarding of at least one bit from the feedback signal.
a microprocessor operable to execute program code.

13. The apparatus of claim 12, wherein the program code initiates the storage of the feedback signal with increased precision,

14. The apparatus of claim 12, wherein program code initiates the discarding of a least significant bit of the feedback signal.

15. The apparatus of claim 12, wherein program code initiates the buffering of the feedback signal with double precision.

16. The apparatus of claim 12, wherein program code initiates communication of the feedback signal to the microprocessor.

17. The apparatus of claim 12, wherein program code initiates reception of the incoming signal.

18. The apparatus of claim 12, wherein program code initiates a shift of the feedback signal one bit toward a least significant bit.

19. The apparatus of claim 12, wherein program code initiates production of a modified signal by using the feedback signal to modify the incoming signal.

20. The apparatus of claim 19, wherein program code initiates multiplication of the modified signal by a scaling coefficient.

21. The apparatus of claim 19, wherein program code initiates outputting the modified signal.

22. The apparatus of claim 12, wherein program code initiates detection of an overflow occurrence prior to discarding a bit from the feedback signal.

23. A program product for preventing overflow in a digital IIR filter, comprising:
a program configured to initiate storage within a memory of a feedback signal, wherein the feedback signal is stored with increased precision, wherein the program initiates the discarding of at least one bit from the feedback signal, wherein the filter uses the feedback signal to modify an incoming signal, wherein the feedback signal comprises a sequence of bits; and
a signal bearing medium bearing the program.

24. The program product of claim 23, wherein the signal bearing medium includes a recordable medium.

25. The program product of claim 23, wherein the signal bearing medium includes a transmission type medium.
